(19) United States
(12) Patent Application Publication
(10) Pub. No.: US 2006/0098887 A1
(43) Pub. Date: May 11, 2006

(54) Mehthod for image conversion

(76) Inventors: Hazem El-Bakry, Mansoura (EG); Roland Faber, Uttenreuth (DE); Uriel Roque, Hamburg (DE); Oliver Schreck, Bamberg (DE)

Correspondence Address: HARNESS, DICKEY & PIERCE, P.L.C., P.O.BOX 8910, RESTON, VA, 20195, US

(21) Appl. No.: 11/130,866

(22) Filed: May 18, 2005

(30) Foreign Application Priority Data
May 19, 2004 (DE) 10 2004 024 879.6

(51) Int. Cl. G06K 9/40

(52) U.S. Cl. 382/254

(57) ABSTRACT

A method is proposed for image conversion of image data with a first contrast range to image data with a second contrast range. Fourier coefficients of a Fourier transform of the image data are entered in a neural network by calculating parameters for carrying out windowing.

The present application hereby claims priority under 35 U.S.C. §119 on German patent application number DE 10 2004 024 879.6 filed May 19, 2004, the entire contents of which is hereby incorporated herein by reference.

### FIELD

The present invention generally relates to a method for image conversion of image data with a first contrast range to image data with a second contrast range.

### BACKGROUND

Particularly in medical imaging, it is frequently necessary to convert the contrast range of the image data obtained from an imaging measurement. Medical imaging represents a major branch of medical diagnosis. For example, methods such as computed tomography or magnetic resonance imaging tomography allow images to be obtained of the interior of the body of an object being examined, and to be displayed on an appropriate medium. The image data obtained from an imaging measurement is nowadays produced virtually exclusively in digital form.

Medical appliances which are used to record measurement data, such as CT scans or MRI scans, allow image data to be obtained, for example in the 12-bit format, so that the gray scale range of this image data covers 4096 gray scale steps. A high contrast range of the image data obtained in this way from the imaging measurement must be changed in a suitable manner to a reduced contrast range, which typically includes 8 bits, that is to say 256 gray steps. Simple linear mapping of the high contrast range of the image data onto the low contrast range is generally not desirable, since this can lead to an unacceptable loss of information in image areas of interest.

Thus, in specific applications in the case of computer tomography image data, only those intensity and gray scale values which are within a relatively narrow gray scale range are of interest for displaying individual organs. A detail from the contrast range of the image data is thus chosen for loss-free imaging of such image areas on a medium, with this detail being located within this relatively narrow gray scale range and having a width which corresponds, for example, to 256 gray scale steps or less. This type of conversion of the contrast range by choice of a detail is referred to as windowing. Intensity or gray scale values which are greater than the upper window value are reproduced as being white on the media, while intensity or gray scale values which are lower than the lower window value are reproduced as being black.

Until now, the contrast range of the image data obtained from the imaging measurement has generally been converted manually by an operator of a corresponding imaging appliance. The operator or else a diagnosing doctor in this case defines a position and a window width for the windowing for the display on a corresponding medium, depending on the type of image and/or the type of imaging measurement. In the case of MRI scanning, for example, this involves a considerable amount of time, however, since, as before, the actual diagnosis in this field is carried out by looking at film sheets and all the images must be viewed, and their contrast range adapted, before filming. Reliable automatic windowing of the contrast range of the image data obtained would thus offer considerable advantages.

However, until now, it has not been possible to implement known methods for automatic windowing since it has not been possible for them to produce acceptable results for the large number of possible image types. The known methods are based on analysis of the gray scale values of the image data obtained, with contrast compression then being carried out on the basis of this data. One example of this is the histogram uniformity method.

DE 197 42 188 A1 discloses a method for conversion of the contrast range of digital image data, in which local image areas of the image are considered for analysis. This method requires analysis of the gray scale range of the image data, for which the background is assessed, a mask is produced and parameters are estimated, and are evaluated for conversion of the contrast range, in order to compress the contrast range of locally slowly changing regions of the image, while essentially retaining fine structures. However, even this method does not lead to a satisfactory result for the operator or for the diagnosing doctor for all possible image types and, furthermore, is associated with considerable computation complexity.

DE 102 13 284 A1 discloses a method of the type mentioned initially, in which a first contrast range of the image data obtained by the imaging measurement is automatically converted to image data with a second contrast range, and is displayed on a medium. In this case, additional information about the image obtained from a DICOM header, and the respective measurement method are automatically used to determine an image class from a predetermined group of different image classes, and the conversion process is carried out using parameters associated with that image class. This method ensures a high degree of optimization of the contrast range for display on a medium.

However, the image classes would have to be continually extended and adapted, particularly when new measurement methods have been developed, in order to allow, for example, appropriate conversion of image data obtained with new measurement methods. In addition, the method results in the disadvantage that only the additional information from the DICOM header is read for the choice of the appropriate image class. The actual contrast range of the image data is in this case ignored. Even though the contrast range of an image is closely linked to the measurement method that is used, special cases are feasible where the classification of the image data in a specific image class does not lead to optimum conversion of the contrast range.

U.S. Pat. No. 5,995,644 discloses a system in which a number of neural networks are used to determine parameters for windowing. In this case, a feature generator is first of all used to produce a feature vector, which evaluates both histogram data and direct image information. On the basis of the features, a classifier classifies the image data in predetermined image classes. Each image class has an associated bi-modal linear estimation network and a radial bases function network-based non-linear estimator.

A data fusion system uses the output values from the two estimators to calculate the parameters for windowing, that is to say the window width and the window center. All the information-processing parts of the described system with the exceptions of the feature generator are in the form of neural networks. This method has the disadvantage of the complex structure and the large number of neural networks required, whose training involves considerable effort. U.S. Pat. No. 6,175,643 B1 describes a method by which the system described in U.S. Pat. No. 5,995,644 can be matched to personal user requirements.

“Automatic adjustment of display window for MR images using a neural network”, by A. Ohhashi et al. in the Proceedings of SPIE, Vol. 1444, pages 63-74, 1991 describes a method for determination of parameters for windowing. In this case, two neural networks assess the quality of an image that has been converted using test parameters. In this case, a feedback value from the neural networks is used to measure the image quality. New test parameters are checked until the feedback value has reached a maximum. This method has the disadvantage of the large number of attempts which in some circumstances are required to find the maximum.

JP 08096125 A describes a display unit for medical image data, in which pixels of an image are selected by a threshold value comparison of density values. These pixels are used to calculate a density histogram, whose values are used to control a neural network. The neural network calculates a window width and a window center for contrast conversion.

“Extracting Information-Dense Vectors from Images for Neural Network Classifiers” by W. Malyj et al, in Conf. on Neural Networks 1991, IJCNN-91, Vol. 2, page 940 describes the application of a digital sampling detector to a two-dimensional Fourier transform of image data for reduction of input vectors for a neural network. This results in a considerable smaller density vector for entering in the neural network, thus allowing classification of biological antibody reactions.

### SUMMARY

An object of an embodiment of the present invention is to specify a method for image conversion by windowing, by which automatic conversion of the contrast range of the image data for a large number of image types is possible in a simple manner, taking account of the respective image data.

An object may be achieved by a method of at least one embodiment. The use of a neural network allows the method to be adapted well to the respective image data. This lessens or even avoids at least one of the disadvantages of the prior art, and/or achieves enhanced or even optimum conversion of the contrast range. In a first method step of an embodiment, input parameters for the neural network are obtained from the image data, with a Fourier transformation being carried out during the determination process. The input parameters are then entered in the network, in a second step. This network uses the input parameters to calculate a center and a width for the optimum window for conversion of the respective image data.

In one advantageously refined embodiment of the method, any background which does not contribute to the image information may be removed before the image data is entered in the neural network. This reduces the amount of data to be processed, thus making it easier to calculate the conversion parameters.

Once the background has been removed, different images are in general of different sizes. In this case, it is advantageous to scale the size of the image to a standard size in order that the number of input parameters which are transferred to the neural network always remains the same. In particular, it is advantageous to reduce the size of the image, since this further reduces the amount of data to be processed.

Coefficients of a Fourier transform of the image data are particularly suitable for entering in the neural network. This corresponds to a further reduction of the amount of data to be processed, and thus to a substantial simplification of the calculation to be carried out by the neural network. One advantageously refined embodiment of the method uses the Fourier transformation to determine a Fourier transform of the image data, whose coefficients are transferred as input parameters to the neural network.

In pattern recognition, it is normal not to use all of the Fourier coefficients for further processing. One advantageously refined embodiment of the method relates to selection of Fourier coefficients for entering in the neural network.

A modified form of embodiment of the method does not determine the Fourier transform of the image data itself, but a previously calculated histogram of the image data.

### BRIEF DESCRIPTION OF THE DRAWINGS

Further advantages and features of the invention can be found in the following text in conjunction with example embodiments that are explained in the attached figures, in which:

FIG. 1 shows a schematic illustration of windowing for image conversion,

FIG. 2 shows, schematically, a flowchart for carrying out an embodiment of the method, and

FIG. 3 shows, schematically, a flowchart for a second example embodiment of the method.

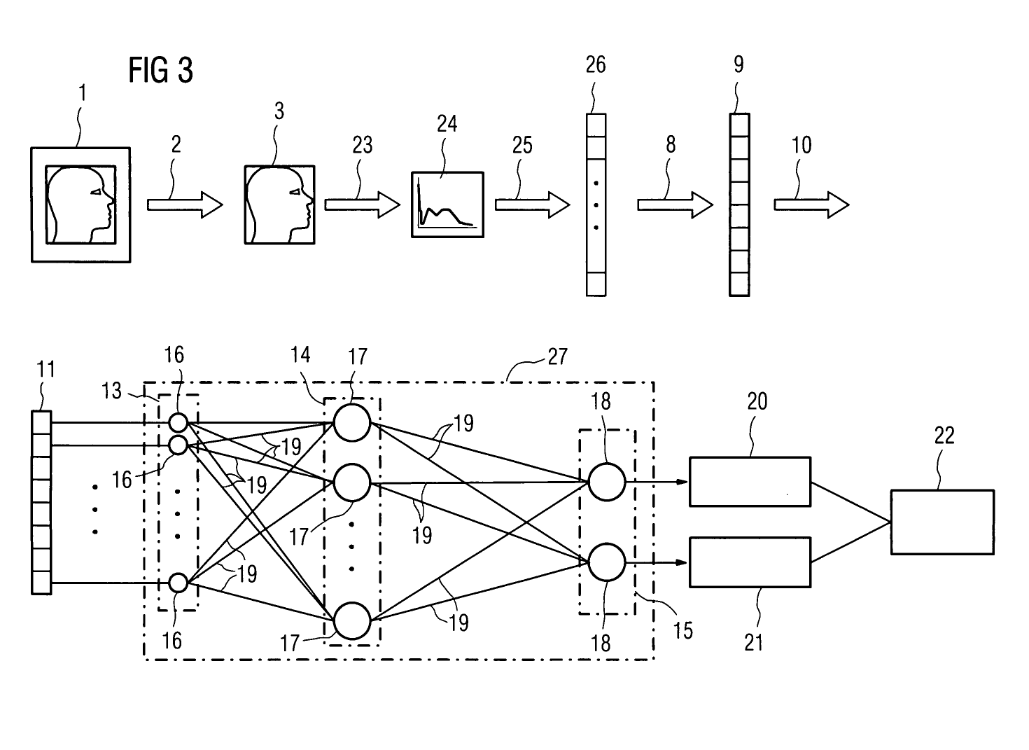

### DETAILED DESCRIPTION OF THE EXAMPLE EMBODIMENTS

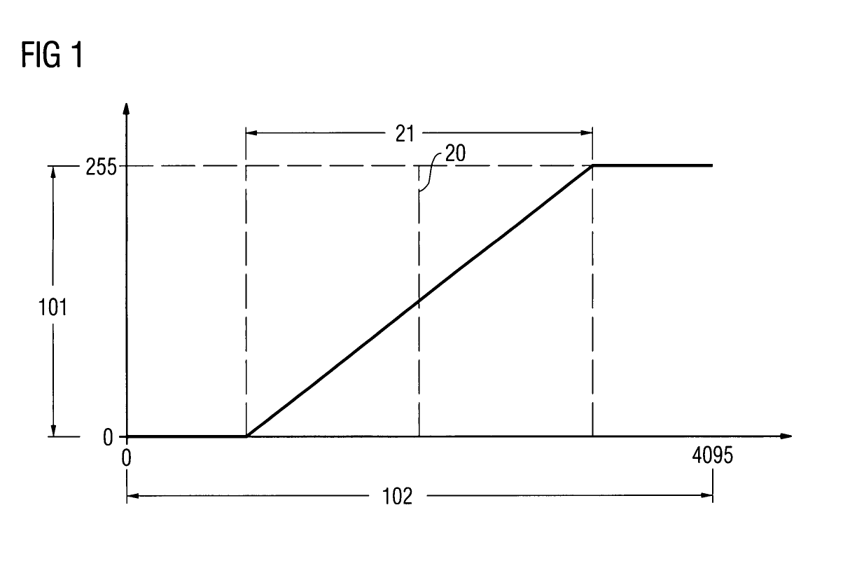

In both example embodiments, the parameters for windowing of the image data may be calculated using a neural network. In this case, the neural network calculates a window center and a window width, by which the contrast range of the image data is converted, as shown in FIG. 1. In this figure, the converted contrast range 101 is plotted against the original contrast range 102. The window center 20 and the window width 21 are used to select a detail from the original 4096 gray scale steps, and convert them linearly to 256 gray scale steps.

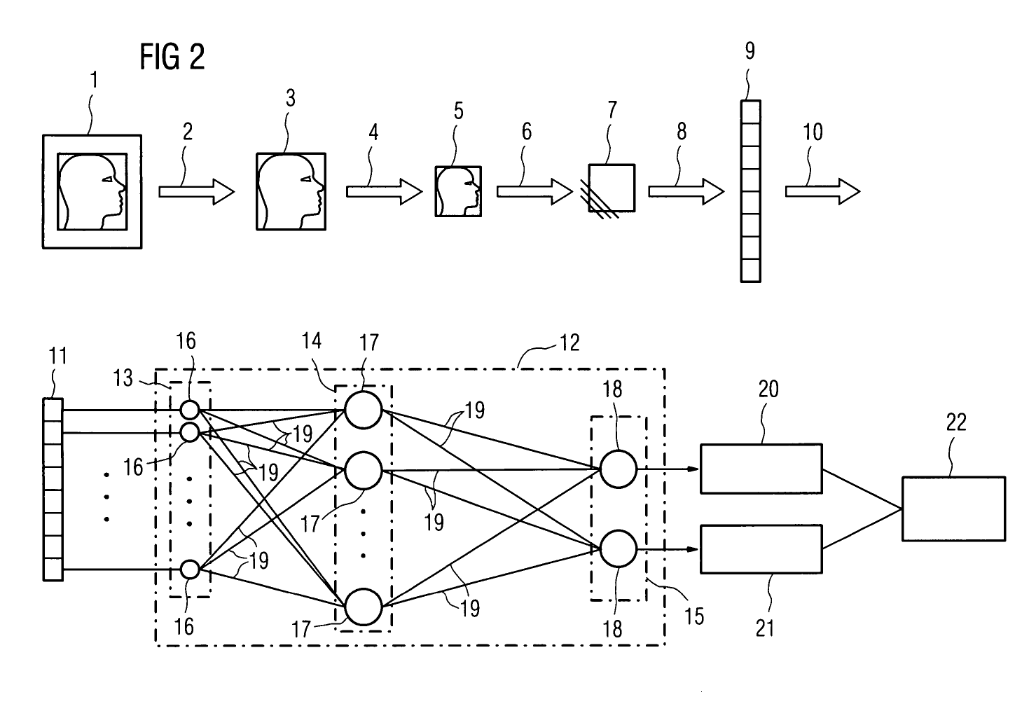

FIG. 2 shows, schematically, how areas of the image which are not required and contain only a background and thus no information that can be evaluated are cut out on the basis of the original image data 1 in a step 2. A histogram of the image data is calculated, and the relevant area is cut out of this in order to automatically distinguish between the relevant area of the image and the unimportant background. By way of example, it is found for MRI scanning images that a high maximum is produced at low frequencies both for T1-weighted images and for T2-weighted images of the background to be cut off, which maximum is cut off automatically in a known manner by computer-based algorithms, and this will not be explained in any more detail here. The chopped image 3 is scaled down in a step 4 to a standard size of 32×32 pixels. This is done since the removal of the background can result in different image sizes for each image. In addition, the amount of data to be processed is reduced.

A two-dimensional Fourier transform 7 is calculated in a step 6 by Fast Fourier Transformation from the down-scaled image 5. In pattern recognition using two-dimensional Fourier transforms, it is normal not to use all of the Fourier coefficients for further processing, but to use a number of Fourier coefficients defined in advance. In a corresponding manner, eight diagonals are selected from the Fourier transform 7 of the reduced-size image 5 in a step 8.

The resultant thirty six Fourier coefficients 9 are converted in a step 10 using the formula
C_{v=log(|}F_{v|}²)
where Fᵥ denotes the Fourier coefficients 9. The Fourier coefficients Cᵥ 11 that have been standardized in this way are used as input parameters for the neural network 12.

The neural network has three levels 13, 14 and 15, with the first level having thirty six input neurons 16, into which the Fourier coefficients are entered. The second, concealed level 14 has twelve neurons 17, and the third level 15 has two output neurons 18. All the neurons in the level are connected to all of the neurons in the respectively adjacent levels via weighted connections 19. The two output neurons 18 emit values, normalized with respect to the interval [−1,1] for the window center 20 and the window width 21 in order to carry out the windowing 22.

The neural network 12 is based on the perceptron model, with the neurons having a tansigmoid transfer function. Resilient back-propagation is used as a learning algorithm, thus minimizing the error rates of the result in the learning process. The weights of the connections between the neurons are changed appropriately for this purpose.

FIG. 2 shows a further embodiment of the method. Using the same original image file 1, the background of the image that is not required is once again cut off in the step 2. Size scaling is not carried out in this example embodiment. In contrast to the example embodiment described above, no Fourier transform is produced from the image itself, but a histogram 24 of the image is calculated in advance in a step 23. A Fourier transform 26 is then calculated from this histogram 24 in a step 25. This also forms the basis for dispensing with the scaling of the image. Reducing the size would result in the loss of important image data for calculation of the histogram 24.

Nineteen Fourier coefficients 9 are selected from the Fourier transform 26, which is one-dimensional in this example embodiment, and are once again converted in step 10 using the formula
C_{v=log(|}F_{v|}²)
where Fᵥ, denotes the Fourier coefficients 9. The Fourier coefficients Cᵥ 11 which have been standardized in this way are used as input parameters for the neural network 27.

In the same way as in the previous example embodiment, the neural network 27 is a perceptron network with tansigmoid transfer function, which has been trained by resilient back-propagation. The neural network 27 once again has three levels 13, 14 and 15, with the first level 13 now having nineteen input neurons 16, the concealed level 14 having twelve neurons 17, and the third level 15 having two output neurons 18. All of the neurons in one level are once again connected 19 in a weighted form to all of the neurons in the adjacent levels. As in the first example embodiment, the two output neurons 18 emit values, which have been normalized with respect to the interval [−1,1], for the center 20 and width 21 of the window, by which the contrast range is then converted by using the windowing 22.

Any of the aforementioned methods may be embodied in the form of a system or device, including, but not limited to, any of the structure for performing the methodology illustrated in the drawings.

Further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable non-volatile memory, such as memory cards; and media with a built-in ROM, such as ROM cassettes.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

what is claimed is:

1. A method for image conversion of image data with a first contrast range to image data with a second contrast range via windowing, the method comprising:
determining at least one input parameter for a neural network from the image data, with a Fourier transformation being carried out during the determination process;
entering the at least one input parameter in the neural network; and
calculating a center and a width of a window, for use by the neural network.

2. The method as claimed in claim 1, further comprising:
removing, before the image data is entered in the neural network, an image background which does not contribute to relevant image information.

3. The method as claimed in claim 1, wherein the image data is scaled to a previously defined image size before being entered in the neural network.

4. The method as claimed in claim 1, wherein the Fourier transformation is used to calculate a Fourier transform of the image data.

5. The method as claimed in claim 1, wherein a histogram of the image data is calculated before the Fourier transformation, from which a Fourier transform is then calculated.

6. The method as claimed in claim 5, wherein a selection of Fourier coefficients of the Fourier transforms is entered in the neural network, for processing.

7. The method as claimed in claim 6, wherein numerical values are entered in the neural network for processing, which numerical values are functionally related to the Fourier coefficients of the Fourier transforms.

8. The method as claimed in claim 1, wherein the data which has been entered in the neural network is processed by an input level, a concealed level and an output level.

9. The method as claimed in claim 8, wherein thirty six input neurons in the neural network transmit the entered data via weighted connections to twelve neurons in the concealed level, and the twelve neurons in the concealed level transmit the data via weighted connections to two output neurons in the output level.

10. The method as claimed in claim 8, wherein nineteen input neurons in the input level in the neural network transmit the entered data via weighted connections to twelve neurons in the concealed level, and the twelve neurons in the concealed level transmit the data via weighted connections to two output neurons in the output level.

11. The method as claimed in claim 2, wherein the image data is scaled to a previously defined image size before being entered in the neural network.

12. The method as claimed in claim 4, wherein a histogram of the image data is calculated before the Fourier transformation, from which a Fourier transform is then calculated.

13. The method as claimed in claim 4, wherein a selection of Fourier coefficients of the Fourier transforms is entered in the neural network, for processing.

14. The method as claimed in claim 9, wherein nineteen input neurons in the input level in the neural network transmit the entered data via weighted connections to twelve neurons in the concealed level, and the twelve neurons in the concealed level transmit the data via weighted connections to two output neurons in the output level.

15. A computer program, adapted to, when executed on a computer device, cause the computer device to carry out the method as claimed in claim 1.

16. A computer readable medium, including the computer program of claim 15.

17. A method for image conversion of image data with a first contrast range to image data with a second contrast range, the method comprising:
determining a window, at least one input parameter for a neural network being initially determined, utilizing Fourier transformation, from the image data, and the window being determined from the neural network including the at least one input parameter; and
converting image data with the first contrast range into image data with the second contrast range using the determined window.

18. The method as claimed in claim 1, wherein the image data is scaled to a previously defined image size before being entered in the neural network.

19. A computer program, adapted to, when executed on a computer device, cause the computer device to carry out the method as claimed in claim 17.

20. A computer readable medium, including the computer program of claim 19.
